(19) United States
(12) Patent Application Publication
(10) Pub. No.: US 2025/0094117 A1
(43) Pub. Date: Mar. 20, 2025

(54) MULTIPLE DISPLAY AUDIO MANAGEMENT

(71) Applicant: DELL PRODUCTS L.P., Round Rock, TX (US)

(72) Inventor: Kai Wang, Shanghai (CN)

(21) Appl. No.: 18/480,833

(22) Filed: Oct. 4, 2023

(30) Foreign Application Priority Data
Sep. 14, 2023 (CN) 202311185105.4

(51) Int. Cl. G06F 3/16; G06F 3/14

(52) U.S. Cl. CPC G06F 3/165; G06F 3/1431; G06F 3/1454

(57) ABSTRACT

An information handling system detects execution of an application. If an application window of the application is located at an external display device and the external display device is configured in a duplicate audio mode, then audio output is provided at a default audio endpoint and duplicated at an audio endpoint associated with the external display device. The audio endpoint is configured to be interactive with an object of the application in the display or application window.

### FIELD OF THE DISCLOSURE

The present disclosure generally relates to information handling systems, and more particularly relates to multiple display audio management.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system detects execution of an application. If an application window of the application is located at an external display device and the external display device is configured in a duplicate audio mode, then audio output is provided at a default audio endpoint and duplicated at an audio endpoint associated with the external display device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram of a display device configured for multiple display audio management, according to an embodiment of the present disclosure;

FIGS. 3-4 are block diagrams of two or more display devices associated with one information handling system configured for multiple display audio management, according to an embodiment of the present disclosure;

FIGS. 5-6 are block diagrams of systems for multiple display audio management, according to an embodiment of the present disclosure;

FIG. 7 is a diagram of a user interface of a display audio manager for multiple display audio management, according to an embodiment of the present disclosure;

FIGS. 8-10 are diagrams of an extend audio mode, according to an embodiment of the present disclosure;

FIGS. 11-14 are diagrams of a duplicate audio mode, according to an embodiment of the present disclosure;

FIG. 15 is a diagram of a setup for an extend audio mode with a display device that is configured with a picture-by-picture function, according to an embodiment of the present disclosure;

FIG. 16 is a flowchart of a method for multiple display audio management, according to an embodiment of the present disclosure; and

FIG. 17 is a workflow for multiple display audio management, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

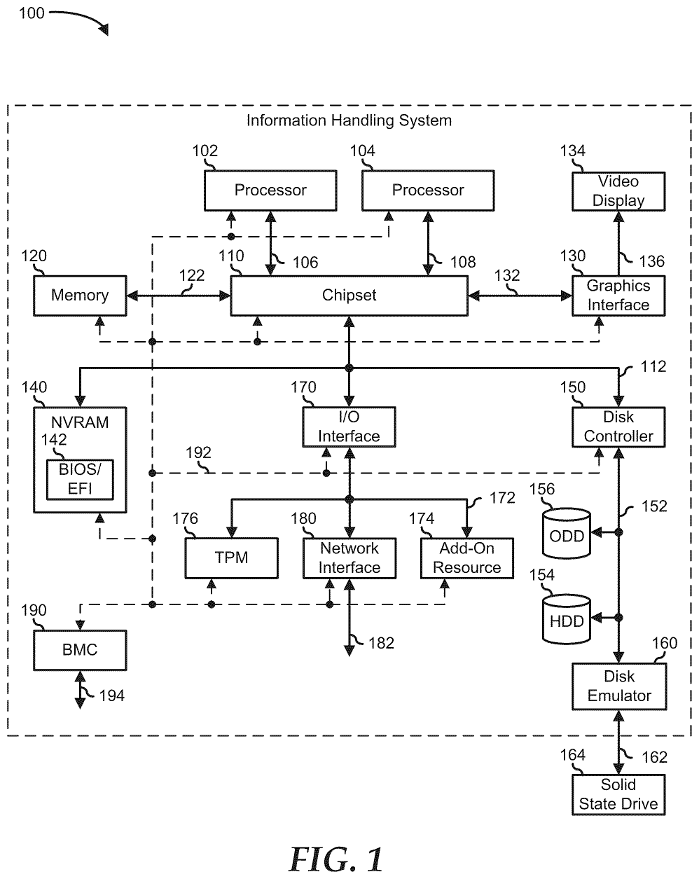

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include a I²C bus, a System Management Bus (SMBus), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I²C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

An operating system may enable multiple display devices to be configured in various modes, such as extend display mode or a duplicate display mode. In the duplicate display mode, content such as an application, a movie, or another type of content that is displayed in one display device may be duplicated in the other display devices. In the extend display mode, content may be displayed across multiple display devices. The extend display mode may also allow different contents to be displayed on different display devices. However, a user typically can only listen to one of the audio outputs of the displayed contents at a time. For example, a user may have to switch back and forth between audio outputs of the different contents. It would be advantageous to have the ability to listen to different audio outputs at the same time. For example, one user may listen to one content using a speaker and another user may listen to another content using a headset at the same time. To address these and other concerns, the present disclosure provides a system and method for multiple-display audio management that provides the ability to manage and control multiple audio outputs.

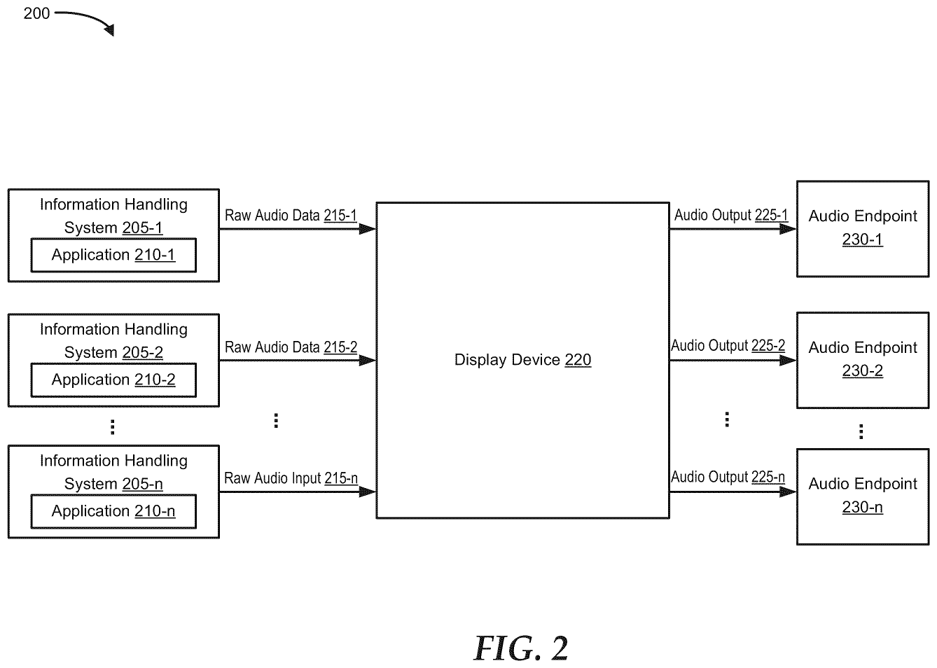

FIG. 2 shows a scenario 200, wherein a display device is configured for multiple display audio management, wherein the display device is connected to two or more information handling systems. Scenario 200 includes information handling systems 205-1 through 205-n, display device 220, and audio endpoints 230-1 through 230-n. Each of information handling systems 205, which may be similar to information handling system 100 of FIG. 1, includes applications 210-1 through 210-n that may provide raw audio data 215-1 through 215-n to display device 220.

Display device 220 may comprise any suitable system, device, or apparatus capable of displaying images, video content, alphanumeric data, and/or graphical user interfaces on a display screen of display device 220. For example, display device 220 may include any type of light-emitting diode (LED), organic LED, liquid crystal display, electroluminescence, or other display technology. Display device 220, which may be similar to video display 134 of FIG. 1, can be integrated into one of information handling systems 205-1 or an external display device, such as a computer monitor, television, a virtual reality headset, a smartphone display, or similar. Display device 220 may be configured to present visual images in multiple display regions from different applications. For example, display device 220 may be capable of a picture-by-picture (PBP) function that separates a display screen of the display device into two or more displays, whereas display device 220 may display two or more pieces of content simultaneously.

Display device 220 may include an audio line out or an audio endpoint for each display. In this example, display device 220 can be associated with audio endpoints 230-1 through 230-n. An audio endpoint may include a device or component configured to produce audio signals, such as an electromechanical transducer. The audio endpoint may also convert an electrical signal into sound. Examples of audio endpoint 230 include a speaker, a headset, a headphone, or similar.

Application 210 may include content with audio and visual image output, such as a software or film application, a movie, or a game. In this example, application 210-1 which is running on information handling system 205-1 may provide raw audio data 215-1 to display device 220. Similarly, application 210-2 which is running at information handling system 205-2 may provide raw audio data 215-2 to display device 220. Accordingly, application 210-n which is running in information handling system 205-n may provide raw audio data 215-n to display device 220. Audio output 225-1 may be based on raw audio data 215-1, while audio output 225-2 may be based on raw audio data 215-2, and audio output 225-n may be based on raw audio input 215-n. Accordingly, audio output 225-1 may be transmitted to audio endpoint 230-1, audio output 225-2 to audio endpoint 230-2, and audio output 225-n to audio endpoint 230-n. Each of audio endpoints 230 may provide sound based on the audio outputs simultaneously.

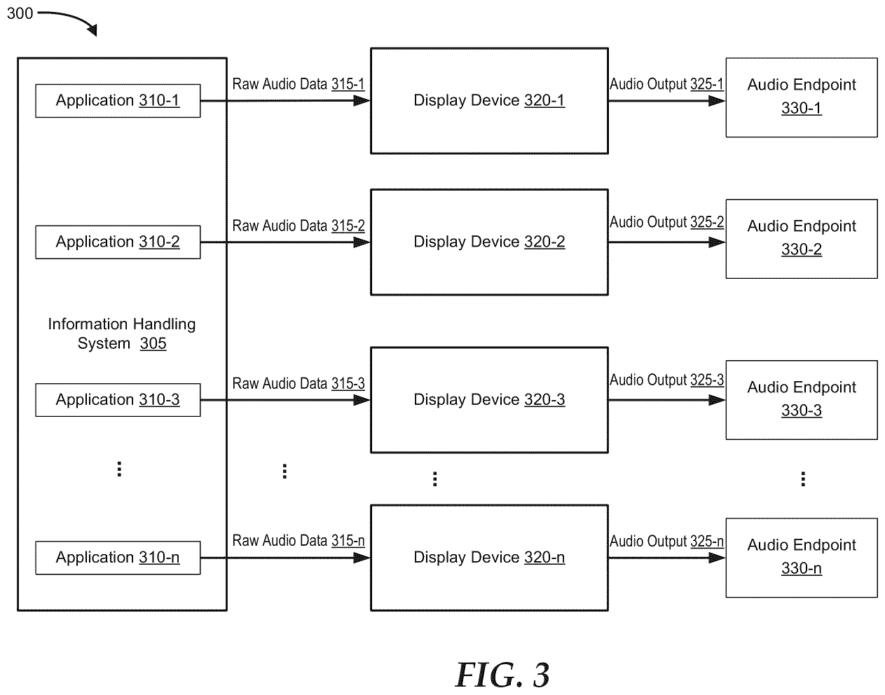

FIG. 3 shows a scenario 300, wherein two or more display devices associated with one information handling system are configured for multiple display audio management. Scenario 300 includes an information handling system 305, display devices 315-1 through 315-n, and audio endpoints 330-1 through 330-n. Each display device is associated with an audio endpoint. Information handling system 305 includes two or more applications, such as application 310-1 through application 310-n.

Each of applications 310 may produce and transmit raw audio data 315 to a display device 320. For example, application 310-1 may transmit raw audio data 315-1 to display device 320-1, while application 310-2 may transmit raw audio data 315-2 to display device 320-2, and application 310-3 may transmit raw audio data 315-3 to display device 320-3. Further, application 310-n may transmit raw audio data 315-n to display device 320-n. An audio output based on the input raw audio data may be provided to one or more audio endpoints. In this example, audio output 325-1, which is based on raw audio data 315-1, may be transmitted to audio endpoint 330-1. Similarly, audio output 325-2, which is based on raw audio data 315-2, may be transmitted to audio endpoint 330-2, and so on.

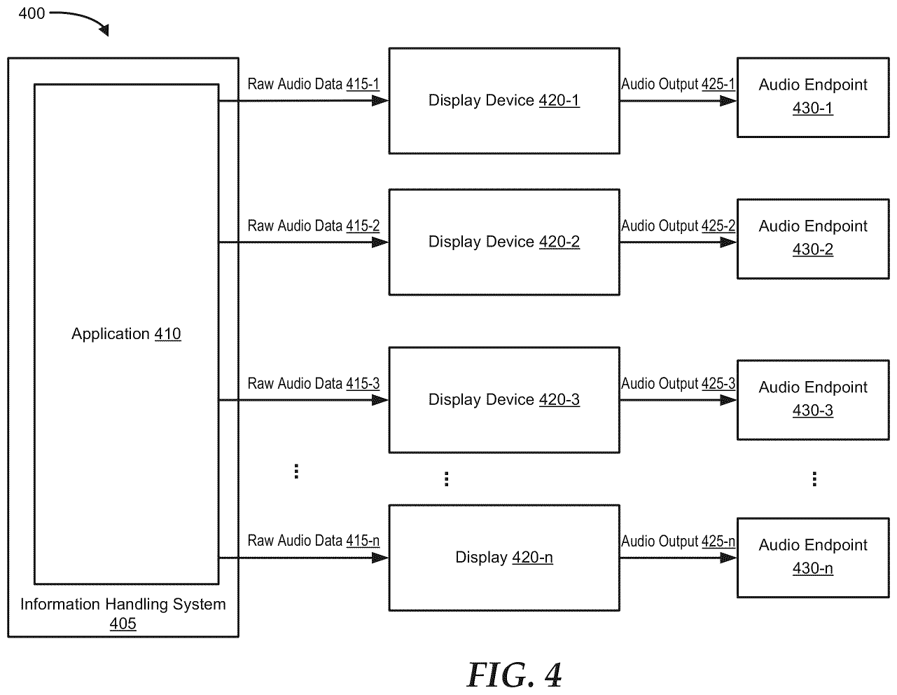

FIG. 4 shows a scenario 400, wherein two or more display devices associated with one information handling system are configured for multiple display audio management. In this scenario, the display devices are associated with one information handling system. Scenario 400 includes an information handling system 405, display devices 420-1 through 420-n, and audio endpoints 430-1 through 430-n. In this example, each one of display devices 420 can be associated with an audio endpoint. Information handling system 405 includes an application 410 which may transmit raw audio data 415-1 through 415-n to display devices 420-1 through 420-n respectively. Audio outputs 425 which are based on the raw audio data may be transmitted to audio endpoints 430. For example, audio output 425-1 may be transmitted to audio endpoint 430-1, while audio output 425-2 may be transmitted to audio endpoint 430-2, and so on.

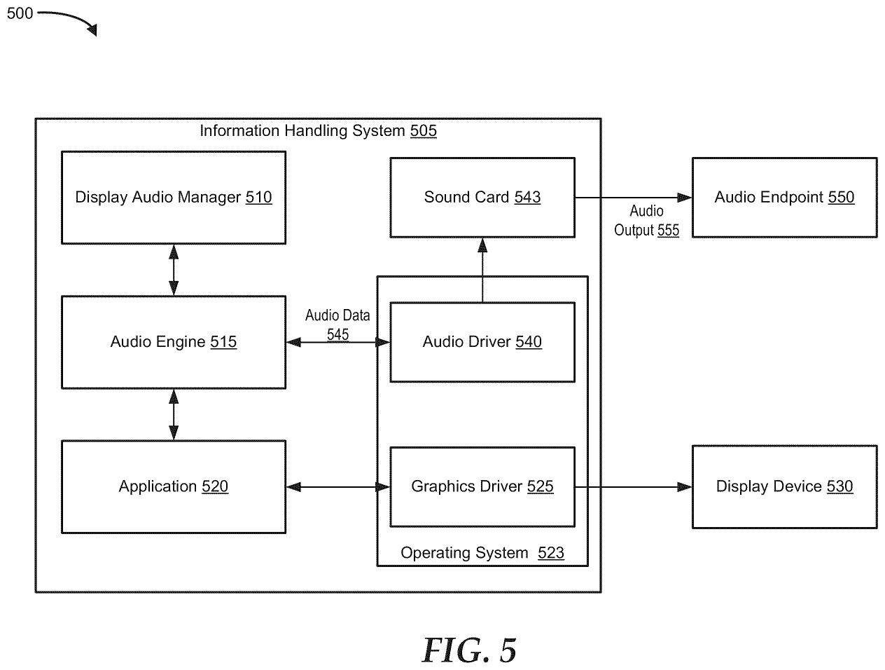

FIG. 5 shows a system 500 for multiple display audio management. System 500 includes an information handling system 505, a display device 530, and an audio endpoint 550. Information handling system 505, which may be similar to information handling system 100 of FIG. 1, includes a display audio manager 510, an audio engine 515, an application 520, an operating system 523, a sound card 543. Operating system 523 includes an audio driver 540 and a graphics driver 525. The components of system 500 may be implemented in hardware, software, firmware, or any combination thereof. The components shown are not drawn to scale and system 500 may include additional or fewer components. In addition, connections between components may be omitted for descriptive clarity.

Display device 530, which may be similar to video display 134 of FIG. 1, includes an audio driver 540. Display device 530 may include an integrated audio endpoint or be connected to an external audio endpoint. In another embodiment, display device 530 may include an integrated audio endpoint and include an external audio endpoint. Audio endpoint 550 may be integrated into display device 530 or plugged in via an audio adapter. Information handling system 505 may also be configured to support two or more graphic cards, and each graphic card may be connected to an audio endpoint via an HDMI port or DualPort™ interface. The graphic card may also have sound card capability. The components of system 500 may be implemented in hardware, software, firmware, or any combination thereof. The components shown are not drawn to scale and system 500 may include additional or fewer components. In addition, connections between components may be omitted for descriptive clarity.

Display audio manager 510 may be configured to monitor and manage one or more audio endpoints that are associated with display devices. As such, display audio manager 510 may keep track of the audio endpoints that may be added and/or removed, such as when a user plugs in or unplugs an audio endpoint to the information handling system and/or a display device whether integrated to or external to the information handling system. In particular, display audio manager 510 may be configured to interface with an audio endpoint 550, and/or audio engine 515 to manage and control multiple audio endpoints based at least in part on display settings including a display mode and an audio mode. In addition, display audio manager 510 may inform audio engine 515 of processing elements in the data paths for the audio streams.

Display audio manager 510 may include a front-end application and a back-end software service. The frontend application may run in a process context while the backend software service may run in a service context. The frontend application of display audio manager 510 may be configured to provide a graphical user interface that a user may use choose to set and/or update audio configuration settings, such as extend audio mode or duplicate audio mode. Accordingly, display audio manager 510 may monitor roles assigned to each of the audio endpoints based on the audio mode. As such, the audio endpoint that will provide the audio output may be manipulated based on the roles assigned to the audio endpoints and/or displays or display devices.

With the extend audio mode, display audio manager 510 may treat the audio output as extended across audio endpoints, wherein display audio manager 510 may automatically change the default audio output based on the location of a display window. For example, if an application window associated with application 520 is currently located at display device 530, then audio output 555 of application 520 may be transmitted to audio endpoint 550. In another example, if the display window associated with application 520 is moved to another display device, then display audio manager 510 may then transmit audio output 555 to an audio endpoint associated with the other display device. In instances wherein the display device includes two displays, such as a display device with the PBP function, display audio manager 510 may transmit audio output 555 to an audio endpoint associated with the display where the display window is located.

With the duplicate audio mode, display audio manager 510 and/or application 520 may treat multiple display devices as one display device, duplicate audio outputs to at least one additional audio endpoint. In duplicate audio mode, the user may also configure display audio selection and perform runtime modification of the audio output(s). Display audio manager 510 and/or application 520 may also modify the audio output at runtime. In addition, display audio manager 510 may be configured to create a virtual audio driver that can interface with sound card 535 to provide another audio output for another audio endpoint.

When the operating system starts and audio engine 515 is initialized, audio engine 515 may enumerate kernel stream filters that represent the audio endpoints. A kernel stream filter may be a group of nodes that encapsulates a process task to be performed on an audio stream. During the enumeration, the audio engine 515 may also instantiate audio drivers including audio driver 540. Audio engine 515 may mix and process audio streams prior to sending them to audio driver 540. For example, audio engine 515 may convert raw audio data into analog data and control audio output prior to rendering the audio stream, such as audio output 555 to sound card 543 which transmits audio output 555 to audio endpoint 550. Sound card 543 may also be included in a graphics card, such as graphics interface 130 of FIG. 1, with sound card capabilities. In this example, audio engine 515 may transmit audio data 545 to audio driver 540. Audio endpoints include integrated speakers and microphones, headsets or headphones, USB audio devices, Bluetooth® audio devices, HDMI audio devices, or similar.

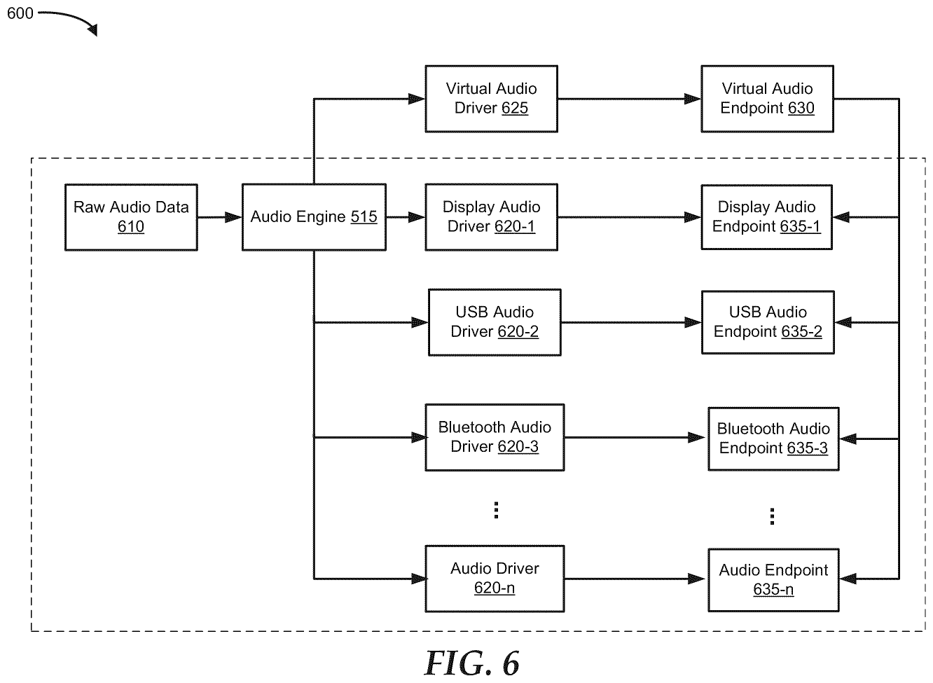

Application 520 may be configured to identify a default audio endpoint associated with it. The operating system may provide a structure for application 520 to send an audio stream to one audio endpoint as decided by operating system heuristics or as chosen by the user, such as via display audio manager 510. Accordingly, application 520 may only send a number of channels of audio stream based on an audio endpoint capability. Thus, if there is one audio endpoint, application 520 may create one audio channel. With a virtual audio driver, which is similar to the virtual audio driver of FIG. 6, application 520 may be configured to a multi-stream audio stream, such as an additional audio signal to wireless audio endpoint peripherals at the same time as the default audio endpoint.

Those of ordinary skill in the art will appreciate that the configuration, hardware, and/or software components of system 500 depicted in FIG. 5 may vary. For example, the illustrative components within system 500 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

FIG. 6 shows a system 600 for multiple display audio management. System 600 includes an audio engine 515, audio drivers 620-1 through 620-n, a virtual audio driver 625, a virtual audio endpoint 630, and audio endpoints 635-1 through 635-n. Audio drivers 620 may be drivers for a variety of audio devices and/or protocols. For example, audio driver 620-1 may be a display audio driver, audio driver 620-2 may be a USB audio driver, and audio driver 620-3 may be a Bluetooth™ audio driver. Similarly, audio endpoints 635 may be audio endpoints of various types. For example, audio endpoint 635-1 may be a display audio endpoint, audio endpoint 635-2 may be a USB audio endpoint, and audio endpoint 635-3 may be a Bluetooth™ audio endpoint. Audio endpoint 635-n may be one or a wired headset, an HDMI or DisplayPort™ audio endpoint, etc. The display audio endpoint may include a built-in speaker and a built-in microphone or microphone array. As shown, each audio endpoint may be associated with a corresponding audio driver. Accordingly, each of the audio endpoints may have different volumes and settings which can be monitored by the display audio manager.

Virtual audio driver 625 may be configured with the ability to interact with different kinds of audio endpoints, such as audio endpoints 635, as an audio stream routing service. Virtual audio driver 625 may be automatically selected as the default audio driver with the different audio modes, such as extend audio mode and duplicate audio mode. Audio stream may be transmitted from audio engine 515 to virtual audio endpoint. In addition, virtual audio driver 625 may be configured to directly interact with audio endpoints 635 as an audio stream routing service by using an audio endpoint selection algorithm. Thus, corresponding audio drivers of the audio endpoints may be bypassed and the audio stream would be transmitted to virtual audio driver 625 which would then transmit the audio stream to virtual audio endpoint 630. This allows the ability to choose one or multiple audio endpoints which permits the user to hear from multiple audio endpoints at the same time.

Raw audio data 610 may be transmitted by an application to audio engine 515. In one embodiment, raw audio data 610 may be transmitted to audio engine 515 from a source, such as an application, an audio engine, etc. In one instance, raw audio data 610 may include uncompressed audio, and one or more pulse code modulation data, among others. Also, raw audio data 610 may not include header information, such as bit depth, number of channels, endianness, sampling rate, etc.

Upon receipt of raw audio data 610, audio engine 515 may process raw audio data 610 generating one or more audio streams or audio output. The audio streams may be rendered to one or more audio output endpoints. If the audio streams are to be rendered to more than one audio endpoint, then a virtual audio driver may be generated for the other audio endpoints.

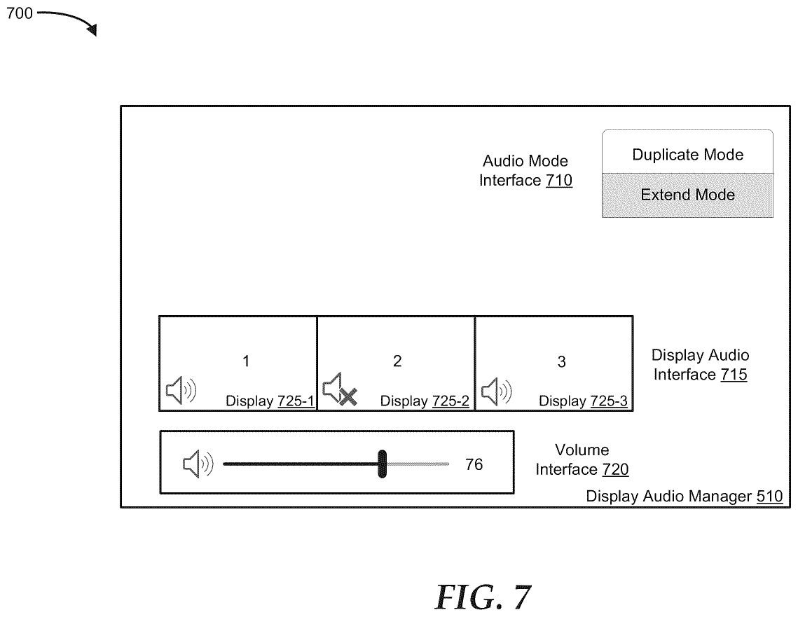

FIG. 7 shows a user interface 700 of display audio manager 510 for multiple display audio management. User interface 700 includes an audio mode interface 710, a display audio interface 715, and a volume interface 720. In this example, audio output is set in extend audio mode for displays 725-1, 725-2, and 725-3, which may be associated with one or more display devices. For example, each one of displays 725-1, 725-2, and 725-3 may be associated with two or three different display devices. In another example, displays 725-1, 725-2, and 725-3 may be associated with one display device.

Audio mode interface 710 allows the user to enumerate the audio endpoints and select one of duplicate audio mode or extend audio mode. The audio modes may be configured to model display modes of displays associated with an information handling system. For example, the extend display mode may be used to extend the display to another display. Accordingly, extend audio mode may also be used to extend audio output to an additional audio endpoint associated with the other display device. The audio outputs may be different for each audio endpoint. For example, one audio output is from a movie application and another audio output is from a gaming application. In addition, the volume of the audio outputs may also be different. Also, the audio endpoints may be of different types. For example, one audio endpoint may be a speaker and another audio endpoint may be a headset. In this example, an audio endpoint of display 725-1 may be used as a primary audio endpoint and the audio output may be extended to the audio endpoint of display 725-3 while muting the audio endpoint associated with display 725-2. The user can listen to one audio stream or two or more audio streams simultaneously, wherein the user can set the volume of each audio stream separately. In this example, the user can listen to audio endpoints associated with display 725-1 and display 725-3 simultaneously.

The duplicate display mode may be used to duplicate a display from one display to another display. Accordingly, the duplicate audio mode may be used to duplicate audio output from one display to another display. The audio outputs may be the same on each audio endpoint. In this scenario, because the audio endpoint associated with display 725-2 is muted, the audio output may be duplicated at the audio endpoint associated with display 725-3.

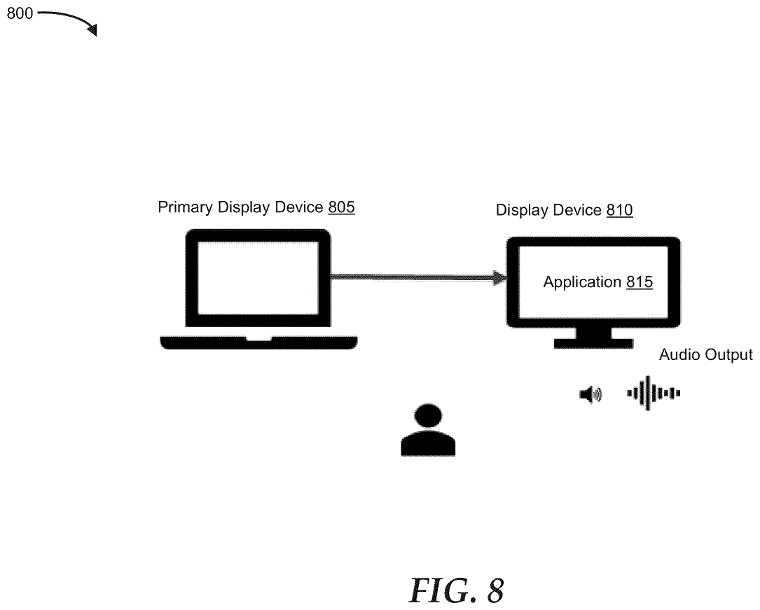

FIG. 8 shows a diagram of a scenario 800 of an extend audio mode. Scenario 800 includes a primary display device 805 and a display device 810 for extending a display window of an application 815. As such, primary display device 805 may have a role of primary or default display, display device 810 has a role of an extension display device, wherein a display is extended across two display screens of the display devices. Similarly, an audio endpoint device associated with primary display device 805 may have the role of primary or default audio endpoint, and another audio endpoint associated with display device 810 may have the role of an extension audio endpoint. In this example, the audio output may be provided by an audio endpoint associated with display device 810 as this is where the display window of application 815 is located. In this example, there is no audio output provided at a speaker associated with primary display device 805. A primary display device may also be referred to as a default display device.

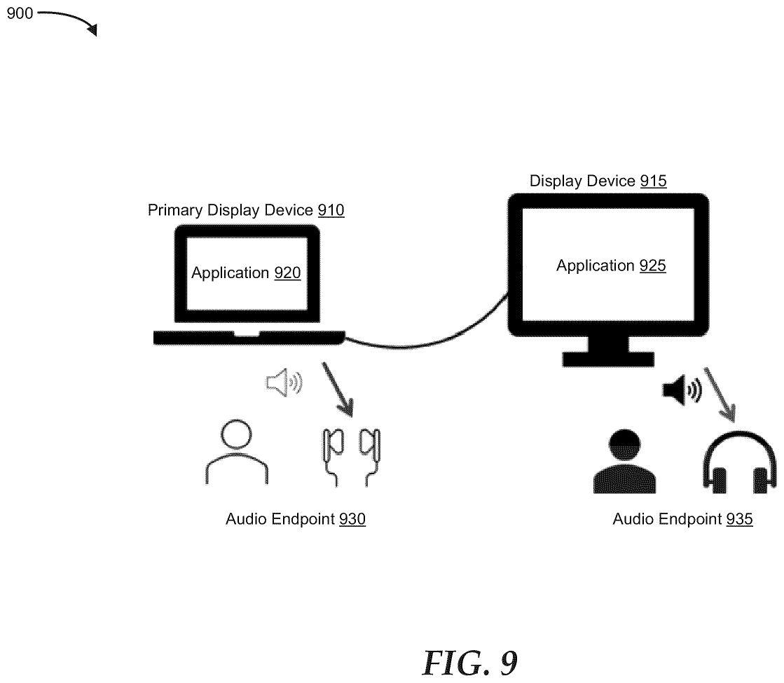

FIG. 9 shows a diagram of a scenario 900 of an extend audio mode. Scenario 900 includes an application 920 displayed at a primary display device 910 and an application 925 displayed at a display device 915. Scenario 900 also includes an audio endpoint 930 which is associated with primary display device 910 and an audio endpoint 935 which is associated with display device 915. Primary display device 910 may be an integrated display device of a portable information handling system. Display device 915 may be a computer monitor that is connected to the portable information handling system. One user may be using audio endpoint 930 to listen to an audio output of application 920. Another user may also be listening to another audio output of application 925 at audio endpoint 935 at the same time. When application 920 is moved from primary display device 910 to display device 915, audio output associated with application 920 may stop being provided at audio endpoint 930 and instead be also moved to audio endpoint 935. The properties of the audio output provided at audio endpoint 930 may be different from the properties of the audio output provided at audio endpoint 935. For example, the audio outputs may be louder than the others.

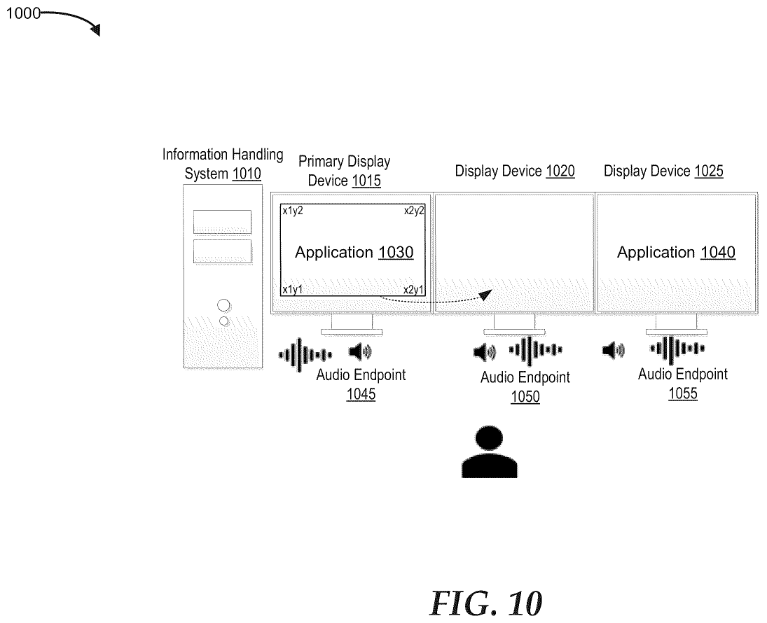

FIG. 10 shows a diagram of a scenario 1000 of an extend audio mode. Scenario 1000 includes an information handling system 1010, a primary display device 1015, a display device 1020, and a display device 1025. In addition, each display device may be associated with an audio endpoint. For example, primary display device 1015 may be associated with audio endpoint 1045, while display device 1020 may be associated with audio endpoint 1050, and display device 1025 may be associated with audio endpoint 1055.

Information handling system 1010 may be running one or more applications, wherein an application may be displayed on a display device. For example, information handling system 1010 may be running an application 1030, which may be a video application, and an application 1040, which may be a gaming application. In this example, application 1030 is displayed at primary display device 1015, while application 1040 is displayed at display device 1025. By default, an audio output associated with application 1030 may be provided at an audio endpoint 1045. Similarly, audio output associated with application 1040 is provided by default at audio endpoint 1055. When an application window of an application is moved from one display device to another display, the default audio endpoint of that application may be changed to the audio endpoint associated with the other display. For example, if application 1030 is moved from primary display device 1015 to display device 1020, then the default audio endpoint may be changed from audio endpoint 1045 to audio endpoint 1050.

The audio output may be based on a location of an application window. The location of the application window may be determined based on a four-corner position approach of its coordinates (x1, y1), (x1, y2), (x2,y1), and (x2, y2). Assuming that each display region in the display device has a screen resolution of 3840×2160 pixels. The display regions may be treated as one big display screen with a resolution of 11520×2160 pixels. For example, if the value of x1 is greater than zero and less than 3840 and y2 is greater than zero and less than 2160, then application 1030 may be presumed to be displayed at primary display device 1015. Accordingly in this example, the application window associated with application 1030 may have moved to display device 1020. This may be determined based on changes in the values of its coordinates. For example, if the value of x1 is greater than 3840 and less than 7680 and the value of y2 is greater than zero and less than 2160, then the application window may be presumed to have been moved to display device 1020. At this point, the audio output may be provided by audio endpoint 1050 instead of audio endpoint 1045.

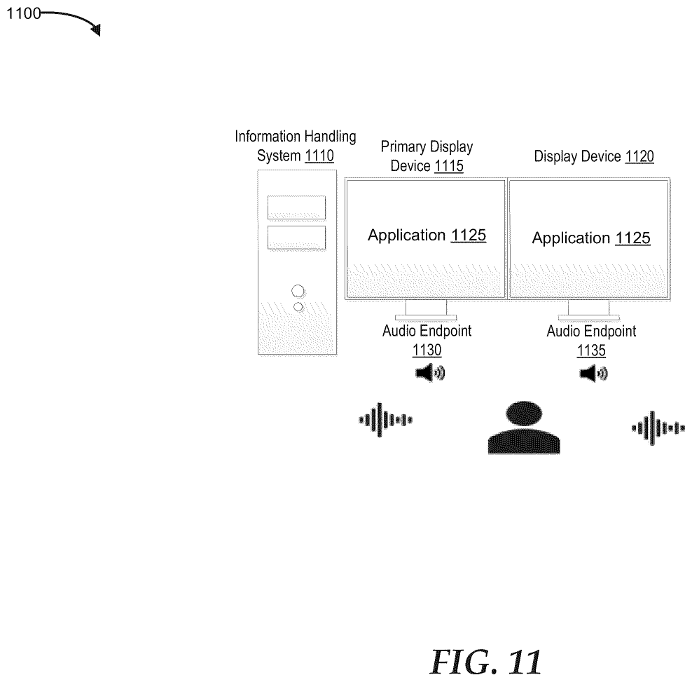

FIG. 11 shows a diagram of a scenario 1100 of a duplicate audio mode. Scenario 1100 includes an information handling system 1110, a primary display device 1115, and a display device 1120. In this scenario, primary display device 1115 may assume a role of primary or default display device, while display device 1120 may assume the role of a duplicate display device, wherein primary display device 1115 and display device 1120 may be combined and used as one display. Primary display device 1115 includes an audio endpoint 1130 while display device 1120 includes an audio endpoint 1135. Accordingly, audio endpoint 1130 may assume the role of primary or default audio endpoint, and audio endpoint 1135 may assume the role of duplicate audio endpoint.

Information handling system may be running an application 1125 which may be displayed at primary display device 1115 and duplicated at display device 1120. Accordingly, a default audio output of application 1125 may be audio endpoint 1130 while a duplicate audio output may also be provided at audio endpoint 1135. By doing this, the audio output may be provided at the same time from two audio endpoints, such as a left speaker and a right speaker resulting in a theater or stereo mode for certain applications, such as music, a movie, or a gaming application.

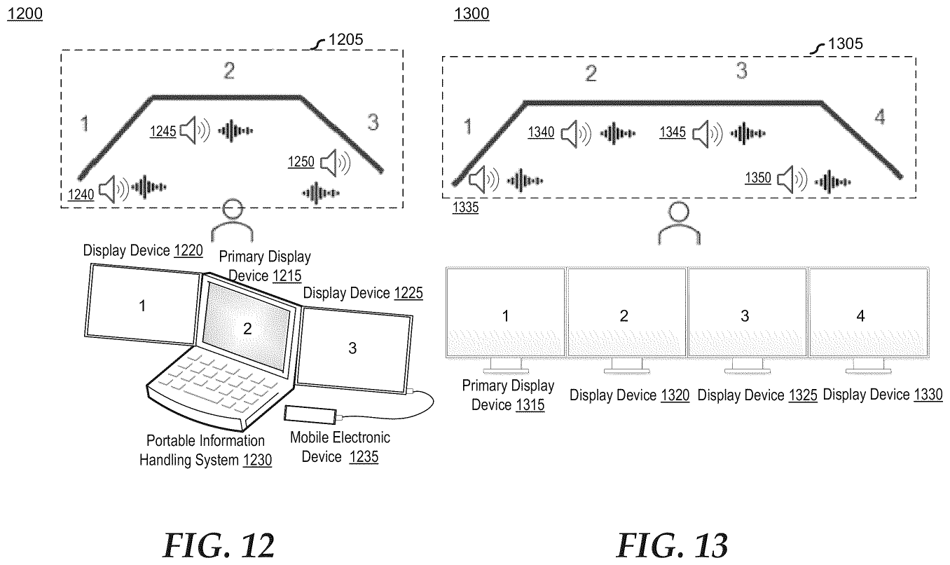

FIG. 12 shows a diagram of a setup 1200 of a duplicate audio mode. Setup 1200 includes a portable information handling system 1230 with an integrated primary display device 1215 and portable external monitors, such as display device 1220 and display device 1225 arranged according to a layout 1205. Layout 1205 may depict how audio outputs may be provided to audio endpoint 1240 and duplicated at audio endpoints 1245 and 1250 at the same time. This may give a user a theater and stereo surround experience. Setup 1200 may also include a mobile electronic device 1235, such as a personal digital assistant, a tablet, a smartphone, or a similar device. This mobile electronic device can also be used as an additional duplicate display device. As such, the audio output may also be duplicated at its audio endpoint.

FIG. 13 shows a diagram of a setup 1300 of a duplicate audio mode. Setup 1300 includes a primary display device 1315 and display devices 1320, 1325, and 1330. The display devices may be arranged according to layout 1305. In this setup, the audio output of an application displayed at the display devices may be provided at audio endpoint 1335 and duplicated at audio endpoints 1340, 1345, and 1350. Accordingly, setup 1300 may provide the user with a theater and stereo surround experience similar to setup 1200.

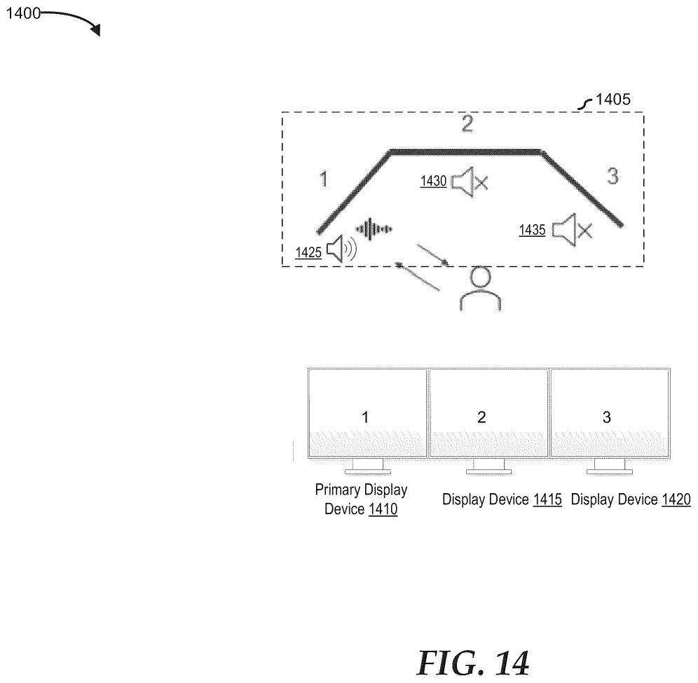

FIG. 14 shows a diagram of a setup 1400 of a duplicate audio mode. Setup 1400 includes a primary display device 1410 and display devices 1415 and 1420 which may be arranged according to a layout 1405. Primary display device 1410 may assume a primary or default display device role while display devices 1415 and 1420 may assume a duplicate display device role. With the duplicate audio mode, the display devices may be used as a single display device. By manipulating audio outputs across the different audio endpoints, the duplicate audio mode may be used to provide dynamic sound control as an immersive experience for a user, such as in a gaming or movie application. By default, visual images associated with an application are typically displayed on a primary display device. Accordingly, an audio output of the application is typically provided by an audio endpoint of a primary display device and duplicated at the audio endpoints of the other display devices.

However, in this example, instead of the audio output provided by default at audio endpoint 1425 and duplicated at audio endpoints 1430 and 1435, the audio output may be interactive. For example, the audio output may be provided based on an activity associated with a display window or an object of the application in the display window. In particular, when there is activity or movement of an object at one of the display windows, then the audio output may be provided by the audio endpoint associated with that display window or display device. For example, in a gaming application, the audio may be provided by the audio endpoint associated with the display device wherein a shooting is occurring. At the same time, the audio endpoints of the other display devices may be muted. When the shooting moves to another display device, then the audio output may also move to the audio endpoint associated with the other display device while the other audio endpoints may be muted.

In this example, assuming that each display device or display has a screen resolution of 3840×2160 pixels. The display devices may be treated as one big display screen with a resolution of 11520×2160 pixels. The audio output may be based on the location of an object in an application window. For example, assuming that the object is associated with coordinates (x, y) in pixels and x is greater than zero and less than 3840 and y is greater than zero and less than 2160, then the object is located at the first display device, which is primary display device 1410. When the object moves, its coordinates (x, y) in pixels change. For example, it may be determined that the object is currently located in display device 1415 when the value of its x coordinate is greater than 3840 and less than 7680 while the value of its y coordinate is greater than zero and less than 2160. At this point, the audio output may be provided by audio endpoint 1430 instead of audio endpoint 1425, as the object is now displayed in display device 1415.

In another example, the audio output may be based on the location and interaction of a user with a cursor in an application window by the user, wherein the cursor may be associated with an input device, such as a mouse, a touchpad, a trackball, or similar. For example, in a gaming application, the user may use the mouse to perform an action, such as clicking the mouse to shoot at something in the game. Accordingly, the audio output may be provided based on the location of the cursor, wherein the shootings originate.

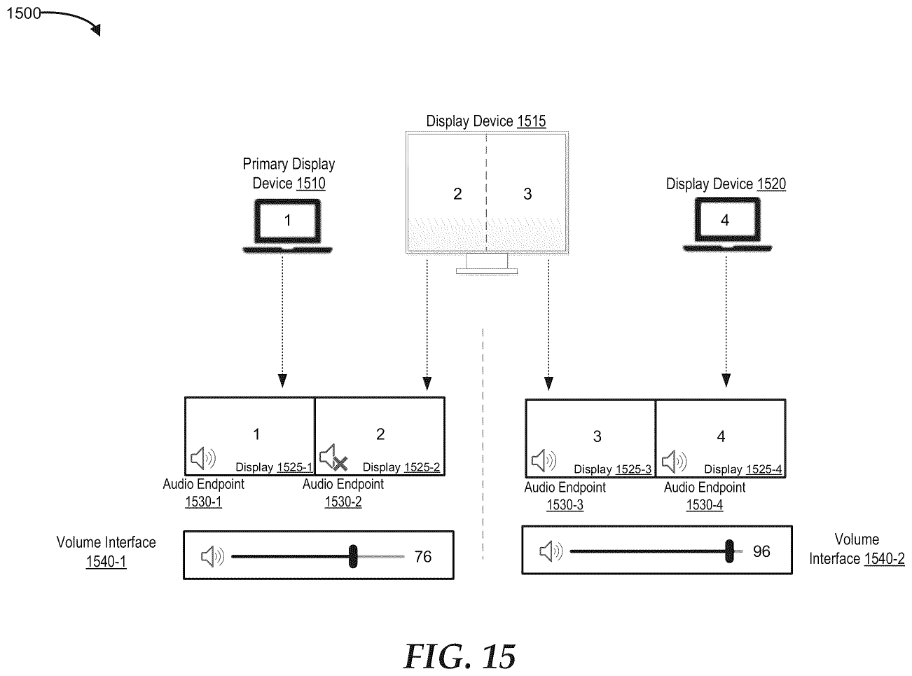

FIG. 15 shows a diagram of a setup 1500 for an extend audio mode with a display device that is configured with a PBP function. Setup 1500 includes a primary display device 1510, a display device 1515, and a display device 1520. Primary display device 1510 may be an integrated display device of a portable information handling system. Display device 1515 may be an external display device with the PBP function. In this example, display device 1515 may include two display regions. Display device 1520 may be an integrated display device of another portable information handling system. The portable information handling systems may each be running different operating systems. For example, the portable information handling system associated with primary display device 1510 may be running a Windows® operating system while the portable information handling system associated with display device 1520 may be running a Linux® operating system.

Primary display device 1510 may be associated with a display 1525-1 while display device 1515 may be associated with displays 1525-2 and 1525-3. Display device 1520 may be associated with display 1525-4. In this example, an audio endpoint may be associated with a display. For example, audio endpoint 1530-1 may be associated with display 1525-1 while audio endpoint 1530-2 may be associated with display 1525-2. In addition, audio endpoint 1530-3 may be associated with display 1525-3, while audio endpoint 1530-4 may be associated with display 1525-4.

Accordingly, audio output from an application shown at display 1525-1 may be provided at audio endpoint 1530-1 while audio output from an application shown at display 1525-2 may be provided at audio endpoint 1530-2. Also, audio output from an application shown at display 1525-3 may be provided at audio endpoint 1535-3 while audio output from an application shown at display 1525-4 may be provided at audio endpoint 1535-4. Each audio endpoint may be controlled by a display audio manager. As such, each audio output may be muted and/or its volume adjusted. In one example, volume interface 1540-1 may control audio endpoints 1530-1 and 1530-2, while volume interface 1540-2 may control audio endpoints 1530-3 and 1530-4.

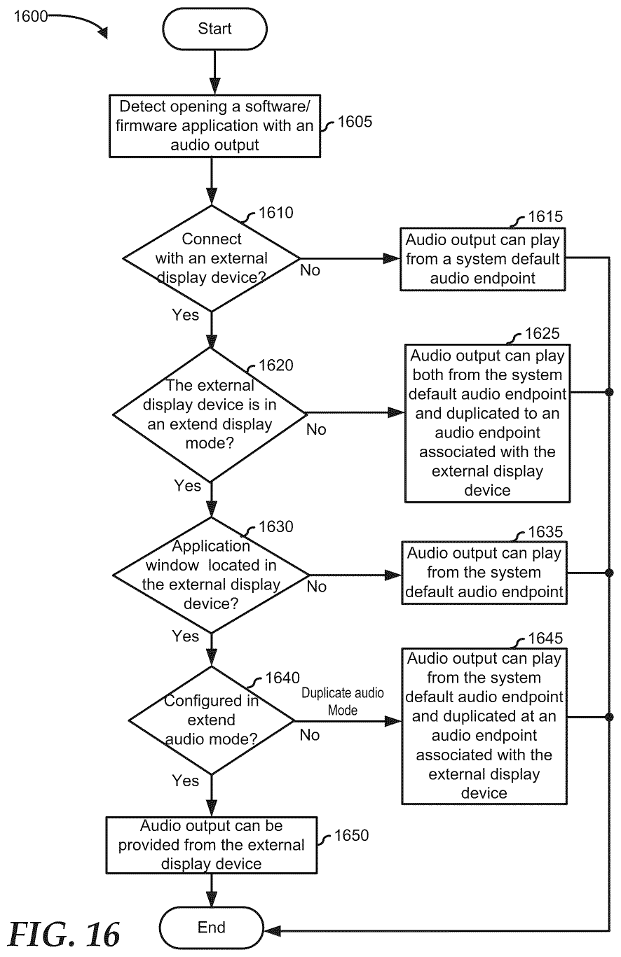

FIG. 16 shows a flowchart of a method 1600 for multiple-display audio management. Method 1600 may be performed by one or more components of system 500 of FIG. 5. In particular one or more blocks of method 1600 may be performed by display audio manager 510. However, while embodiments of the present disclosure are described in terms of system 500 of FIG. 5, it should be recognized that other systems may be utilized to perform the described method. One of skill in the art will appreciate that this flowchart explains a typical example, which can be extended to advanced applications or services in practice.

Method 1600 typically starts at block 1605 where a display audio manager 510 may detect that an application with an audio output is opened or executed. The opening or execution of the application may be detected by an operating system. The method may proceed to decision block 1610 where a display audio manager may determine whether the information handling system is connected to an external display device. If the information handling system is connected to the external display device, then the “YES” branch is taken, and the method proceeds to decision block 1620. If the information handling system is not connected to the external display device, then the “NO” branch is taken, and the method proceeds to block 1615 where the audio output may be provided via a system default audio endpoint. The default audio endpoint may be associated with an integrated display device of the information handling system.

At decision block 1620, the method may determine whether the external display device is in an extend display mode. If the external display device is in the extend display mode, then the “YES” branch is taken, and the method proceeds to decision block 1630. If the external display device is not in extend display mode, wherein the external display device is in a duplicate display mode, then the “NO” branch is taken, and the method proceeds to block 1625 where the audio output may be provided by the system default audio endpoint and an audio endpoint associated with the external display device. The system default audio endpoint may be an audio endpoint associated with a display device configured as a primary display device or the display device where an application window associated with the application is currently on display.

At decision block 1630, the method may determine whether the application window associated with the application is displayed on the external display device. If the application window is displayed on the external display device, then the “YES” branch is taken, and the method proceeds to decision block 1640. If the application window is not displayed in the external display device, then the “NO” branch is taken, and the method proceeds to block 1635 where the audio output can play from a system default audio endpoint.

At decision block 1640, where the method may determine whether the external display device is configured in an extend audio mode or a duplicate audio mode. If the external display device is configured in extend audio mode, then the “YES” branch is taken, and the method proceeds to block 1650. If the external display device is not configured in extend audio mode, wherein the audio mode is in the duplicate audio mode, then the method proceeds to block 1645 where the audio output may be provided by the system default audio endpoint and duplicated at an audio endpoint that is associated with the external display device. At block 1650, the audio output may be provided by an audio endpoint associated with the external display device.

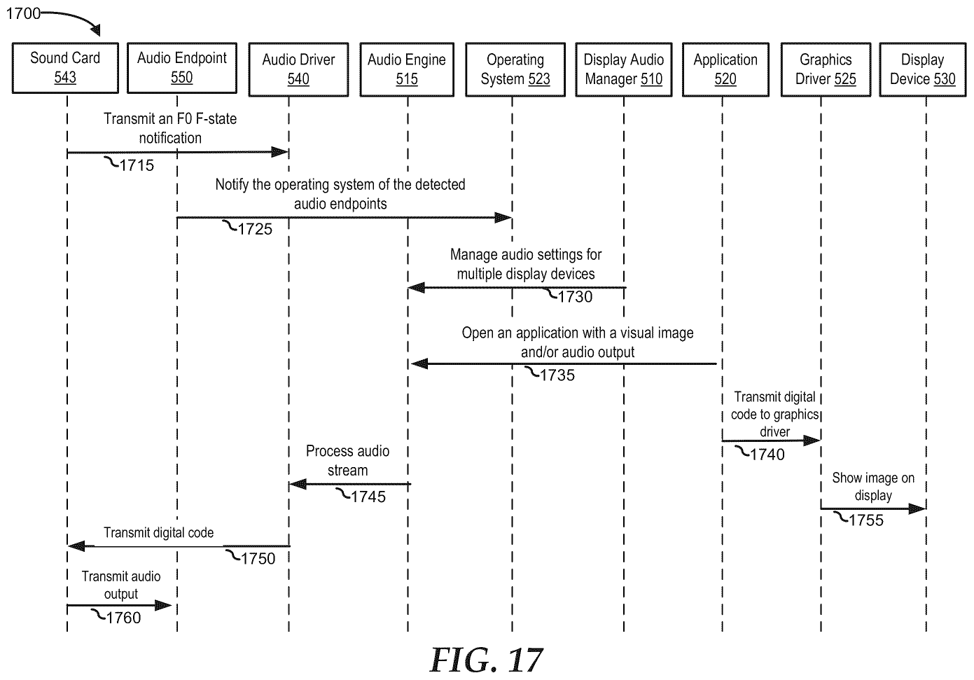

FIG. 17 shows a workflow 1700 associated with multiple-display audio management architecture. Workflow 1700 may be associated with one or more components of system 500 in FIG. 5. For example, workflow 1700 includes sound card 543, audio endpoint 550, audio driver 540, audio engine 515, operating system 523, display audio manager 510, application 520, graphics driver 525, and display device 530. However, while embodiments of the present disclosure are described in terms of system 500 of FIG. 5, it should be recognized that other systems may be utilized to perform the described method. One of skill in the art will appreciate that this workflow explains a typical example, which can be extended to advanced applications or services in practice. At block 1715, sound card 535 may transmit an F0 F-state notification to audio driver 540. The F-state may be used to notify audio driver 540 of the allocated audio coder/decoder, such as at initialization. The workflow proceeds to block 1725 where the audio engine may notify operating system 523 of the status of audio endpoint 550.

At block 1730, a user may manage audio settings for multiple display devices. For example, the user may choose one of two modes, a duplicate audio mode or an extend audio mode. At block 1735, the user may open application 520 with a visual image and/or audio output. Application 520 may start transmitting digital code to a graphics driver 525 at block 1740. Graphics driver 525 may be a software or firmware that turns the digital code into visual images, pictures, or video. Examples of a graphics driver include a graphics driver that supports Advanced Micro Devices® Eyefinity® technology or Nvidia® surround technology. At block 1745, audio engine 515 may mix and process audio stream. In addition, audio engine 515 may load audio processing objects to audio driver 540. Audio driver 540 may also start transmitting digital code to audio driver 540 or a virtual audio driver at block 1750. The audio driver or the virtual audio driver may be a software or firmware that turns the digital code into sound. The audio driver or the virtual audio driver may provide audio control for a sound card and/or provide audio output to an audio endpoint associated with the display device. For example, the audio output may be transmitted via high definition multimedia interface. At block 1755, graphics driver 1710 may show image on display device 530 using a plurality of pixels. While at block 1755, sound card 543 may transmit audio output to audio endpoint 550 at 1760.

As used herein, a hyphenated form of a reference numeral refers to a specific instance of an element and the un-hyphenated form of the reference numeral refers to the collective or generic element. Thus, for example, information handling system “205-1” refers to an instance of an information handling system class, which may be referred to collectively as information handling systems “205” and any one of which may be referred to generically as an information handling system “205.”

Although exemplary embodiments herein refer to an application, one of skill in the art will appreciate that the examples disclosed herein are applicable to other content, such as a movie or gaming software. In addition, the term “user” in this context should be understood to encompass, by way of example and without limitation, a user device, a person utilizing or otherwise associated with the device, or a combination of both. An operation described herein as being performed by a user may therefore be performed by a user device, or by a combination of both the person and the device.

Although FIG. 16 and FIG. 17 show example blocks of method 1600 and workflow 1700 in some implementations, method 1600 and workflow 1700 may include additional blocks, fewer blocks, different blocks, or differently arranged blocks than those depicted in FIG. 16 and FIG. 17. Those skilled in the art will understand that the principles presented herein may be implemented in any suitably arranged processing system. Additionally, or alternatively, two or more of the blocks of method 1600 and workflow 1700 may be performed in parallel. For example, blocks 1715 and 1720 of workflow 1700 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

1. A method comprising:
detecting, by a processor, execution of an application in an information handling system, wherein the information handling system is connected to an external display device; and
when an application window of the application is located at the external display device and the external display device is configured in an extend audio mode, then audio output is provided at an audio endpoint associated with the external display device via a virtual audio driver.

2. The method of claim 1, wherein the external display device is configured in an extend display mode.

3. The method of claim 1, further comprising if the application window of the application is not located at the external display device, then the audio output is provided at a system default audio output.

4. The method of claim 1, further comprising if the application window is moved from the external display device to another display device, then the audio output may be provided by another audio endpoint that is associated with the other display device.

5. The method of claim 1, further comprising if an object in the application window is moved from the external display device to another display device, then the audio output may be provided by another audio endpoint that is associated with the other display device.

6. The method of claim 1, further comprising if a cursor associated with the application is interacted with by a user and the application window is located at the external display device, then the audio output may be provided by the audio endpoint associated with the external display device.

7. The method of claim 1, wherein a volume of the audio output may be configured by a user.

8. An information handling system, comprising:
a processor; and
a memory device storing instructions that when executed cause the processor to perform operations including:
detecting execution of an application in the information handling system, wherein the information handling system is connected to an external display device; and
when an application window of the application is located at the external display device and the external display device is configured in a duplicate audio mode, then audio output is provided at a default audio endpoint and duplicated at an audio endpoint associated with the external display device via a virtual audio driver.

9. The information handling system of claim 8, wherein the external display device is configured in a duplicate display mode.

10. The information handling system of claim 8, wherein the operations further comprise if the application window of the application is not located at the external display device, then the audio output is provided at a system default audio output.

11. The information handling system of claim 8, wherein the operations further comprise if the application window is moved from the external display device to another display device, then the audio output may be provided by another audio endpoint that is associated with the other display device.

12. The information handling system of claim 8, wherein the operations further comprise if an object in the application window is moved from the external display device to another display device, then the audio output may be provided by another audio endpoint that is associated with the other display device.

13. The information handling system of claim 8, wherein the operations further comprise if a cursor associated with the application is interacted with by a user and the application window is located at the external display device, then the audio output may be provided by the audio endpoint associated with the external display device.

14. The information handling system of claim 8, wherein a volume of the audio output may be configured by a user.

15. A non-transitory computer-readable medium to store instructions that are executable to perform operations comprising:
detecting execution of an application in an information handling system, wherein the information handling system is connected to an external display device; and
when an application window of the application is located at the external display device and the external display device is configured in an extend audio mode, then audio output is provided at an audio endpoint associated with the external display device via a virtual audio driver.

16. The non-transitory computer-readable medium of claim 15, wherein the external display device is configured in an extend display mode.

17. The non-transitory computer-readable medium of claim 15, wherein the operations further comprise if the application window of the application is not located at the external display device, then the audio output is provided at a system default audio output.

18. The non-transitory computer-readable medium of claim 15, wherein the operations further comprise if the application window is moved from the external display device to another display device, then the audio output may be provided by another audio endpoint that is associated with the other display device.

19. The non-transitory computer-readable medium of claim 15, wherein the operations further comprise if an object in the application window is moved from the external display device to another display device, then the audio output may be provided by another audio endpoint that is associated with the other display device.

20. The non-transitory computer-readable medium of claim 15, wherein a volume of the audio output may be configured by a user.
